(19) United States
(12) Patent Application Publication
(10) Pub. No.: US 2015/0158194 A1
(43) Pub. Date: Jun. 11, 2015

(54) Slicing Blade System

(71) Applicant: Knife Solutions, LLC, Las Vegas, NV (US)

(72) Inventors: Dieter Krauss, Engetried (DE); Mitchel LeBrasseur, Kankakee, IL (US)

(73) Assignee: Knife Solutions, LLC, Las Vegas, NV (US)

(21) Appl. No.: 14/100,317

(22) Filed: Dec. 9, 2013

(51) Int. Cl. B26D 1/14; B26D 1/00; B26D 1/26

(52) U.S. Cl. CPC B26D 1/14; B26D 1/26; B26D 1/0006

(57) ABSTRACT

A slicing blade system utilizing an advanced blade edge design optimizing the cutting angle, allowing symmetrical forces on both sides of the blade at the same time to improve slicing. The system includes a blade which includes a blade edge which has been optimized for efficiency and precision. The blade edge includes a front bevel extending a first direction from a bisectional line extending through its tip and a back bevel extending in a second direction therefrom. The blade edge has a cutting wedge angel between the front and rear bevels which ranges between 12 and 45 degrees, depending on the specific product being sliced. The blade's orientation may be altered with respect to the angle between the bisectional line of the cutting wedge and the cutting plane depending on the deformation of the product at the cutting point, the geographical location of slicing, and the desired thickness of slices.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a blade edges and more specifically it relates to a slicing blade system utilizing an advanced blade edge design and orientation for improving efficiency and precision in cutting or slicing various products by optimizing the cutting angle to allow symmetrical forces on both sides of the blade at the same time.

2. Description of the Related Art

Any discussion of the related art throughout the specification should in no way be considered as an admission that such related art is widely known or forms part of common general knowledge in the field.

There continues to be great demand for the slicing of various products, including foods such as meat, sausage and cheese. Generally, automated slicing machines which incorporate a blade are utilized for high-speed precision slicing of such products. Common prior art blades include circular blades which utilize orbital motion for cutting involute blades, sickle-shaped blades, or straight blades.

While there are many variations in prior art blade 11 types, the prior art blade edges 12 utilized in the prior art tend to exhibit similar characteristics. FIGS. 1a, 1b and 1c illustrate exemplary prior art blade edge 12 configurations. As seen therein, the blade edge 12 includes a front cutting bevel 13 which extends angularly outward from a straight rear edge 14. A rear bevel, when present, is supplier-fixed and includes an angle preferably no greater than 5 degrees where provided in such prior art blades 11. Such a configuration provides limited functionality when it comes to high speed slicing or slicing at temperatures, given by the process before. The product being sliced must be readied for slicing efficiency, such as by cooling or heating to reach the proper temperature.

Because of the inherent problems with the related art, there is a need for a new and improved slicing blade system utilizing an advanced blade edge design and orientation for improving efficiency and precision in cutting or slicing various products by optimizing the cutting wedge angle and the orientation of this edge in relation to the cutting plane separately to allow symmetrical forces on both sides of the blade at the same time.

### BRIEF SUMMARY OF THE INVENTION

The invention generally relates to a blade edge which includes a blade which may be utilized independently or as part of a larger slicing assembly. The blade includes a blade edge which has been optimized for efficiency and precision. The blade edge includes a front bevel extending a first direction from a bisectional line of the cutting wedge extending through its tip and a back bevel extending in a second direction therefrom. The blade edge has a cutting wedge angel between the front and rear bevels which ranges between 12 and 45 degrees, depending on the specific product being sliced. The blade's orientation may be altered with respect to the angle between bisectional line of the cutting wedge and the cutting plane depending on the deformation of the product at the cutting point, the geographical location of slicing, and the desired thickness of slices.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1a is a sectional view of prior art blade technology.

FIG. 1b is a close-up upper perspective view of prior art blade technology.

FIG. 1 c is a sectional view of another embodiment of prior art blade technology.

FIG. 2 is a top view of an involute blade incorporating the blade edge of the present invention.

FIG. 3 is a top view of a circular blade incorporating the blade edge of the present invention.

FIG. 4 is a close-up upper perspective view of a blade edge incorporating the present invention.

FIG. 5 is a side sectional view of a blade and blade edges incorporating the present invention.

FIG. 6a is a side sectional view of a first embodiment of the present invention in a first orientation with respect to the cutting plane.

FIG. 6b is a side sectional view of a second embodiment of the present invention in a second orientation with respect to the cutting plane.

FIG. 6c is a side sectional view of a third embodiment of the present invention in a third orientation with respect to the cutting plane.

### DETAILED DESCRIPTION OF THE INVENTION

### A. Overview.

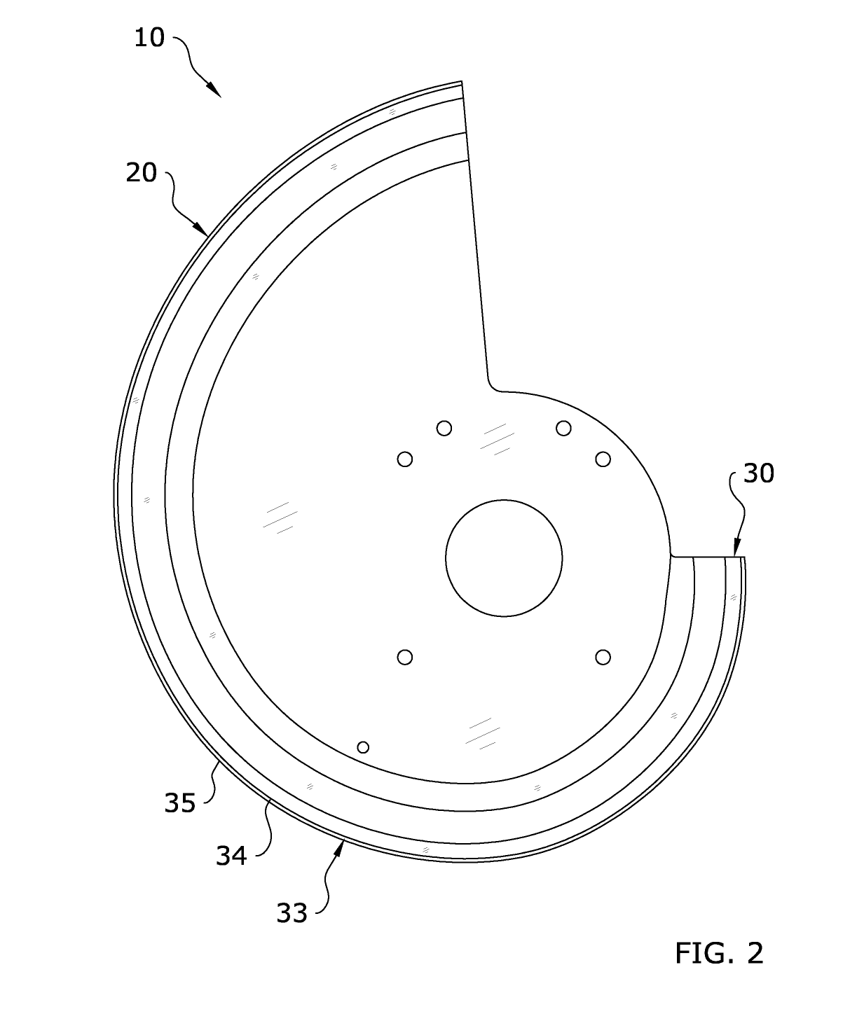

Turning now descriptively to the drawings, in which similar reference characters denote similar elements throughout the several views, FIGS. 2 through 8 illustrate a slicing blade system 10, which comprises a blade 20 which may be utilized independently or as part of a larger slicing assembly 18. The blade 20 includes a blade edge 30 which has been optimized for efficiency and precision. The blade edge 30 includes a front bevel 31 extending a first direction from a bisectional line 36 of the cutting wedge extending through its tip 35 and a back bevel 33 extending in a second direction therefrom. The blade edge 30 has a cutting wedge angel between the front and rear bevels 31, 33 which preferably ranges between 12 and 45 degrees, depending on the specific product being sliced. The blade's 20 orientation may be altered with respect to the angle between the bisectional line 36 of the cutting wedge and the cutting plane depending on the deformation of the product at the cutting point, the geographical location of slicing, and the desired thickness of slices.

### B. Slicing System.

The present invention comprises a blade 20 which may be utilized with a wide range of slicing systems 18. The slicing system will generally be adapted to slice one or more types of food products in an efficient and precise manner. It is appreciated that a wide range of slicing systems 12 may be utilized in combination with the present invention described and claimed herein.

By way of example and without limitation, exemplary slicing systems include manual slicing systems and automated slicing systems. The blade 20 described herein may be utilized in handheld slicing systems or as a component of a larger automated or manual slicing assembly. It should be appreciated that the figures herein merely provide exemplary configurations for use with the present invention, and thus the scope of the present invention should not be construed as limited to any specific type of slicing system. The present invention may be utilized in combination with any device or system which incorporates a blade edge 30 for slicing or cutting various products (food or otherwise).

### C. Blade.

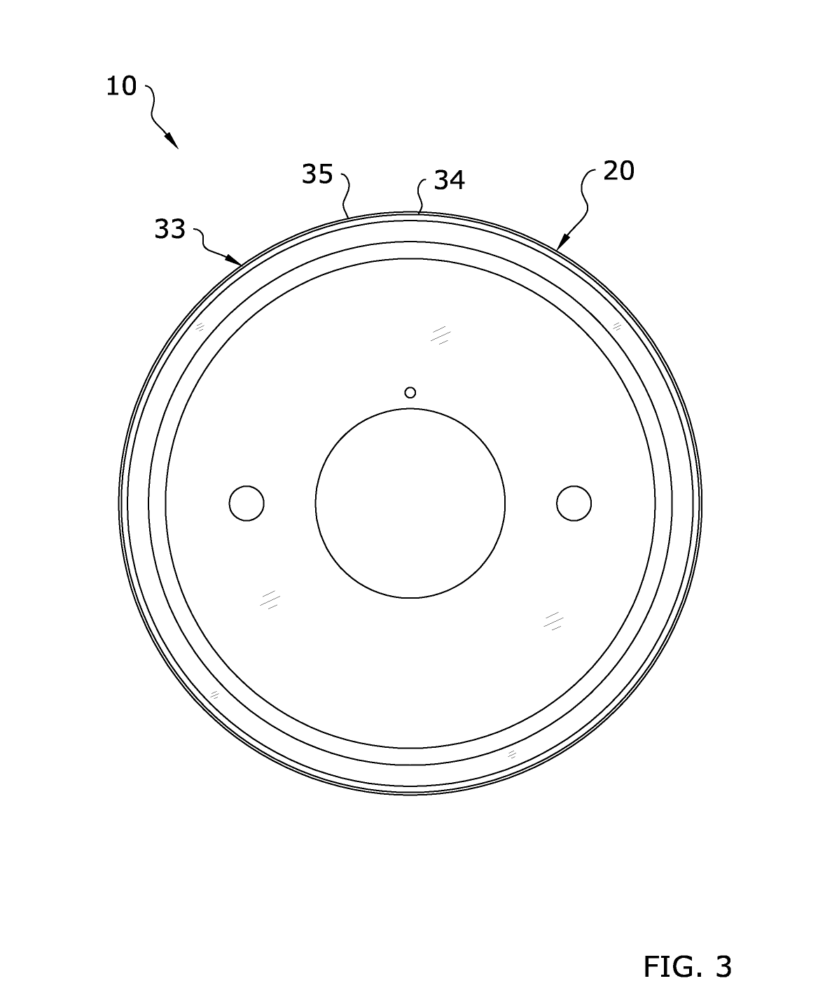

The blade edge 30 described herein may be utilized in combination with a wide range of blade 20 types. FIG. 2 illustrates the present invention incorporated into an involute blade 20. FIG. 3 illustrates the present invention incorporated into a circular blade 20. In either case, these blades 20 may be incorporated into a larger automated or manual slicing system 18.

In other embodiments of the present invention not shown herein, the blade 20 may be a handheld configuration. Such embodiments include blades 20 which may not be circular or involute as shown in the exemplary figures hereto. In some cases, the blade 20 may be comprised of a handheld knife or other manual cutting device. It should be appreciated that the blade 20 may be comprised of a wide range of cutting devices both known in the art and yet to be developed. The scope of the present invention should not be construed as being limited by the exemplary configurations shown in the figures.

### D. Blade Edge.

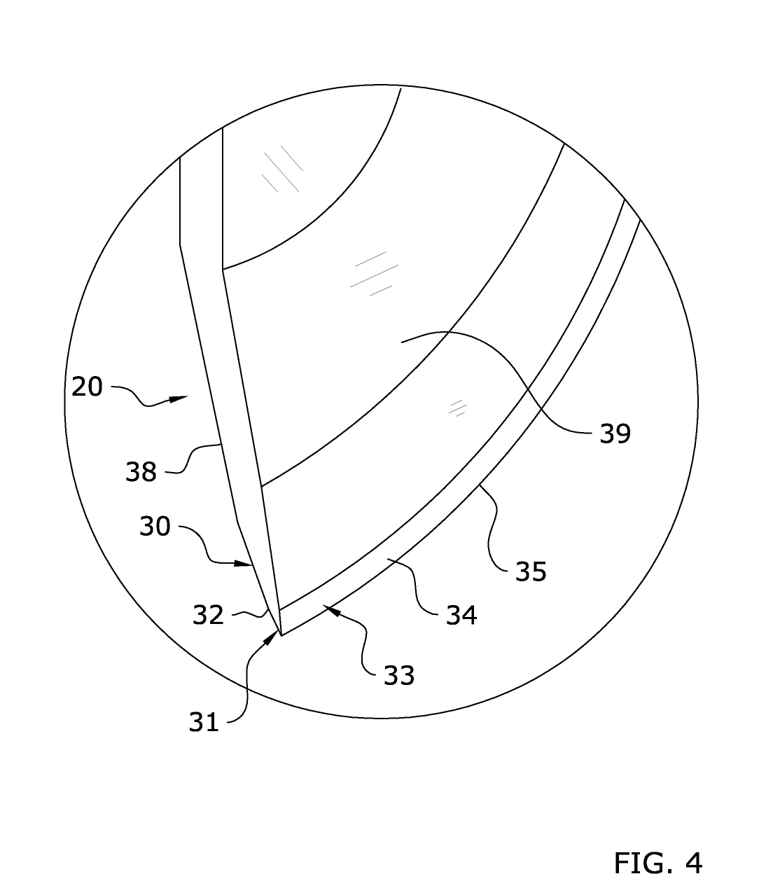

FIGS. 4, 5, 6a, 6b, and 6c provide close-up views of an exemplary blade edge 30 embodying the present invention. The blade edge 30 will generally be rotated either by a manual or automatic slicing machine 18 to cut a product. The blade edge 30 will generally be rotated about a turning axis 17 as shown in the figures.

As shown herein, the blade edge 30 generally includes both a first, front bevel 31 and a second, rear bevel 33. A first spine 38 extends from the front bevel 31 in a direction opposite of the tip 35 of the blade edge 30 and a second spine 39 extends from the rear bevel 33 in a direction opposite of the tip 35 as shown in the figures. The spines 38, 39 will preferably extend parallel or substantially parallel with respect to each other.

The use of the angular rear bevel 33, which does not exist in the prior art, balances the cutting forces being applied to the product, which allows for the product to be warmer during slicing, thus reducing cooling costs and needs for greater inventory on-hand. Additionally, the force and energy necessary for efficient slicing may be minimized, allowing for more efficient slicing systems 18 to be utilized.

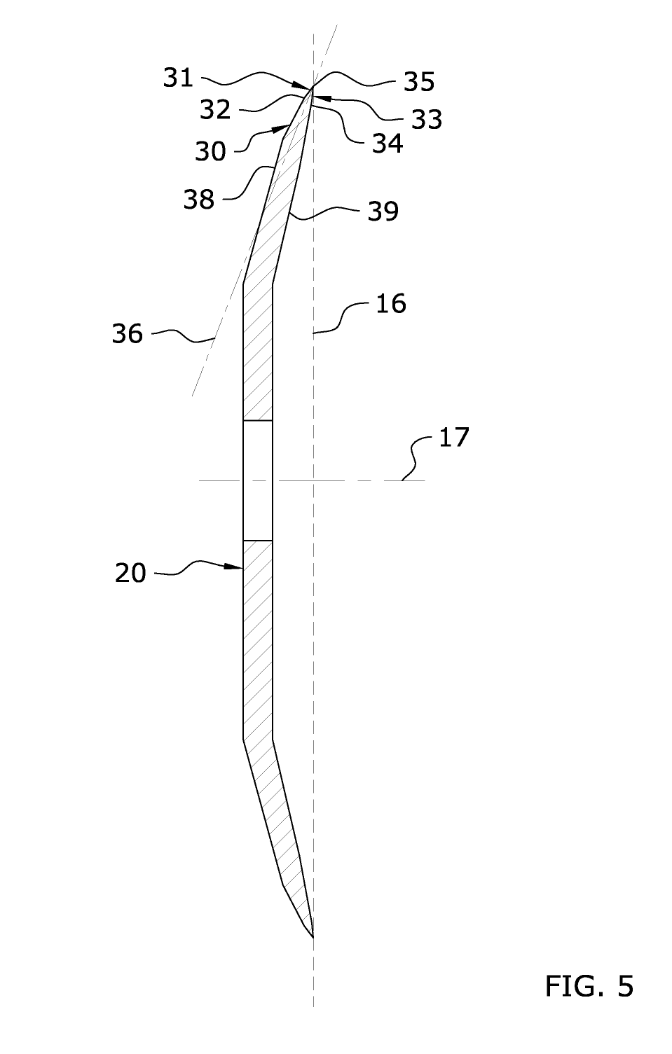

The first bevel 31 is comprised of a first arm 32 and the second bevel 33 is comprised of a second arm 34 as is best shown in FIG. 5. With reference to a bisectional line 36 of the cutting wedge extending straight through the tip 35 of the blade edge 30, the first arm 32 extends radially outward therefrom in a first direction and the second arm 34 extends radially outward therefrom in a second direction. If the bisectional line 36 is oriented vertically with the tip 35 positioned at a lower position, the first arm 32 extends upwardly and to the left with respect to the bisectional line 36 and the second arm 34 extends upwardly and to the right with respect to the bisectional line 36.

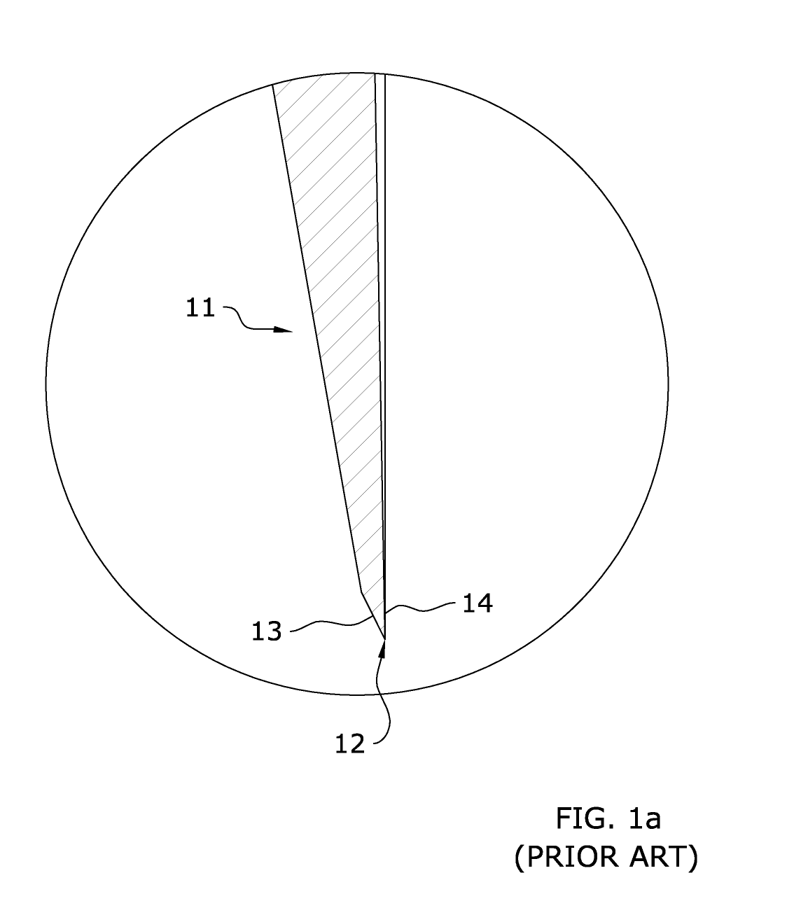

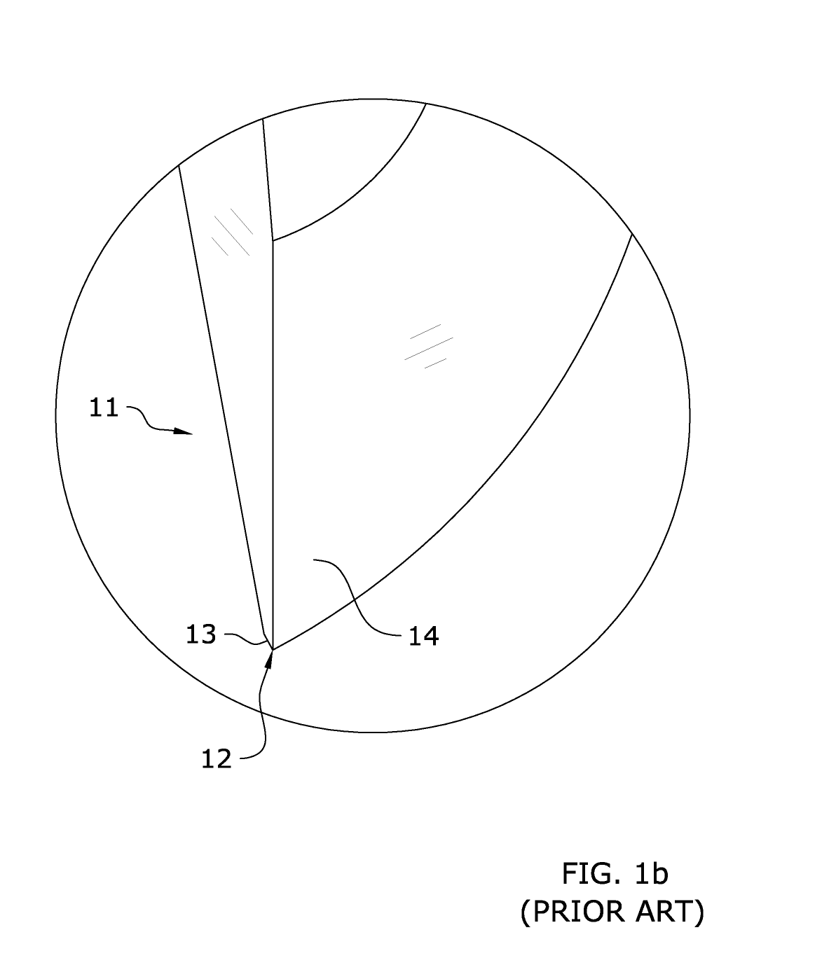

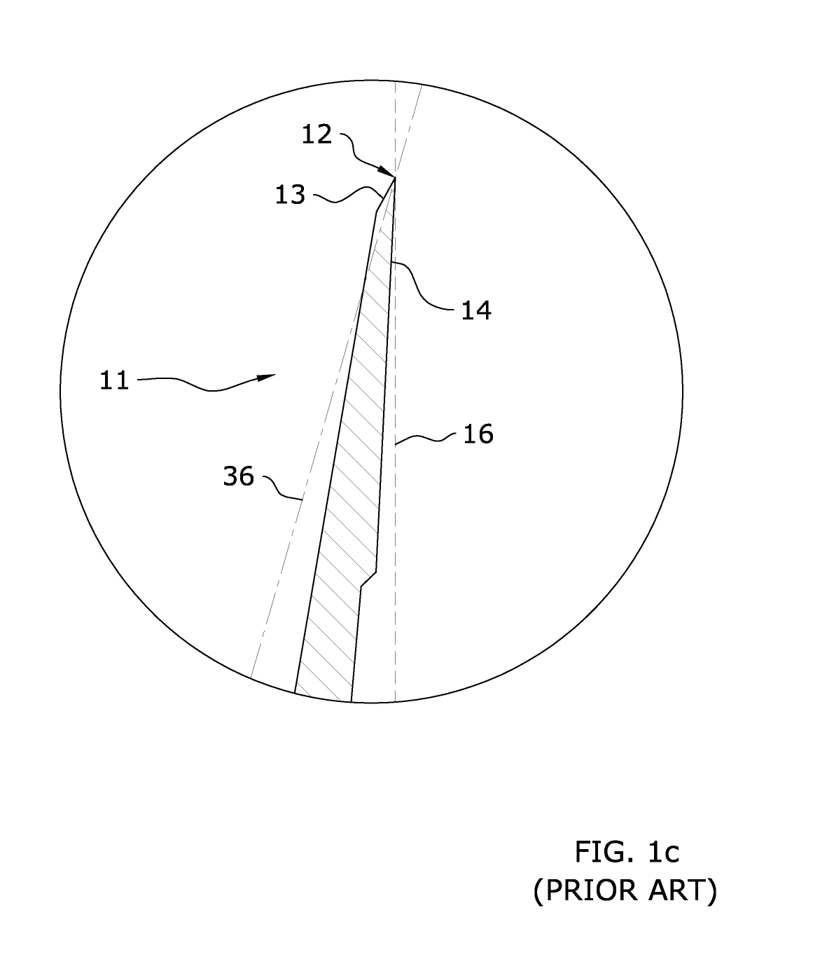

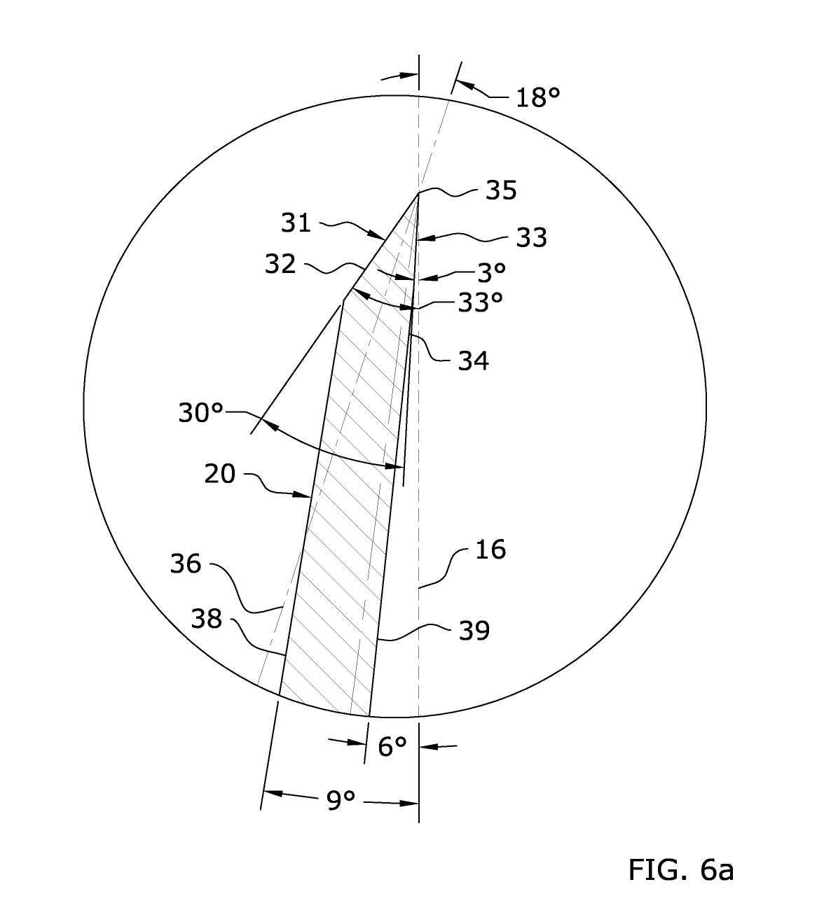

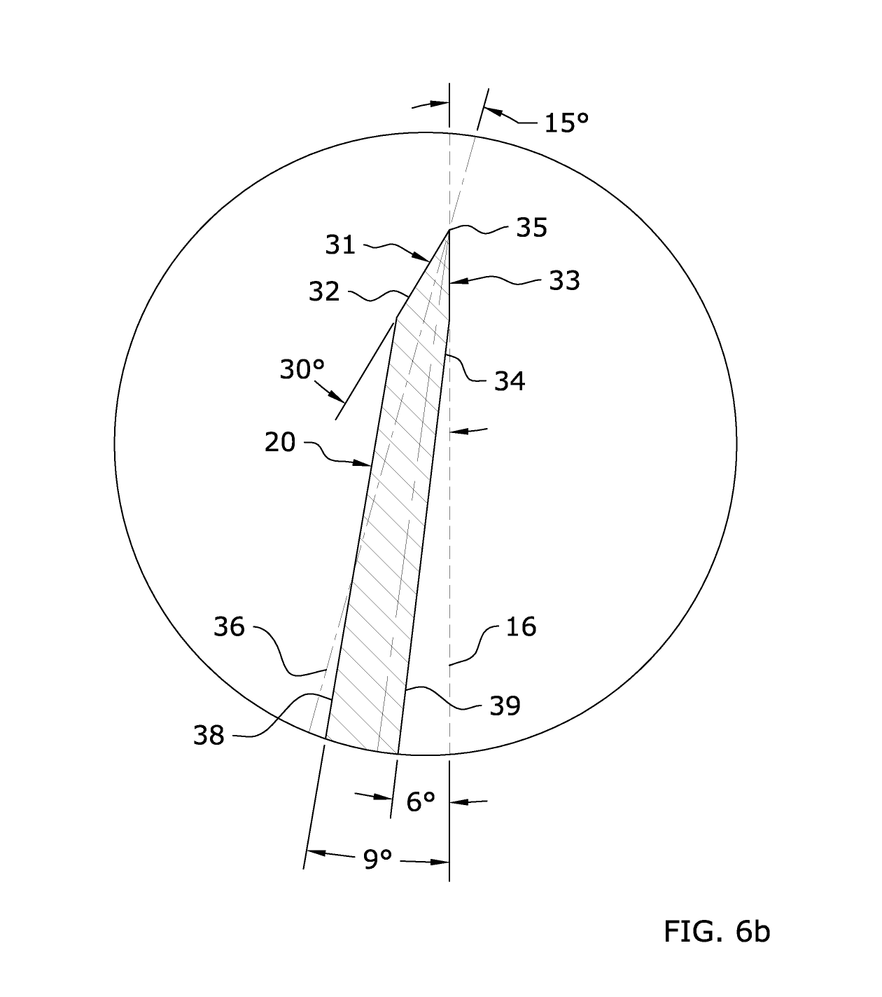

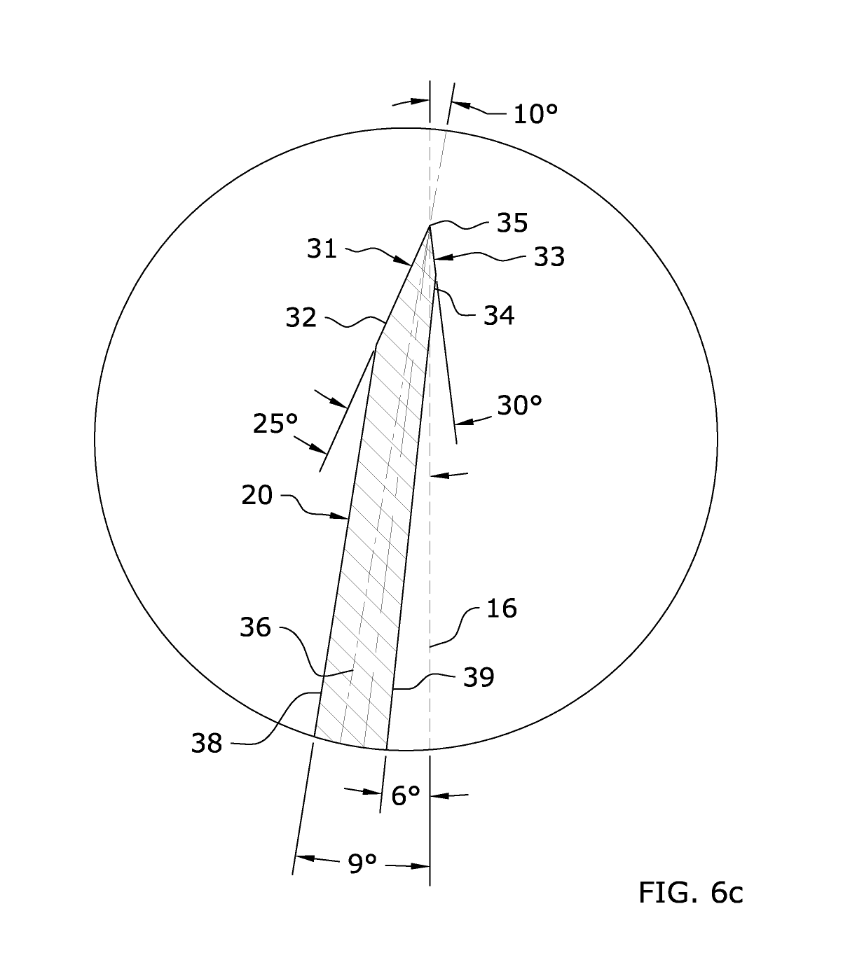

As shown in FIGS. 5, 6a, 6b, and 6c, a cutting plane 16 is defined as a straight line extending between the respective tips 35 of two opposing blade edges 30 on the blade 20. The angles defined between the cutting plane 16 and the respective arms 32, 34, building the cutting wedge, will vary depending on the nature of the use of the present invention, including the type of blade 20 used as well as the product being cut or sliced. In prior art systems as shown in FIGS. 1a, 1b, and 1c, the front bevel 31 and rear bevel 33 (if any) are maintained on the same side of the cutting plane 16 during cutting operations. This prior art configuration requires additional cutting forces which may be reduced by utilizing the new, unique configuration described herein with the present invention.

In a preferred embodiment, the angle of the cutting wedge (the angle between the first arm 32 and the second arm 34) will range between 12 degrees and 45 degrees. In such a preferred embodiment, the angle between the bisectional line 36 and the second arm 34 of the second bevel 33 will be positive, but no greater than 5 degrees. The calculation of the angles for the arms 32, 34 of the bevels 31, 33 will vary depending on the product being sliced. The cutting wedge angle will also depend on the conditions of the geographically location where the cuts are being performed (i.e. elevation, pressure, etc.) Preferably, the angles will be determined such that the angle of the bisectional line 36 of the cutting wedge to the cutting plane is independent from the cutting angle, which will maximize efficiency.

The length of the respective arms 32, 34 of the bevels 31, 33 may also vary depending on the application of the present invention. Generally, in prior art slicing devices 12 such as shown in FIGS. 1a, 1b, and 1c, there will only be a front bevel 13 and a rear edge 14. The front bevel 13 will be comprised of a length which is substantially shorter than that of the rear edge 14 as shown in FIGS. 1a, 1b, and 1c.

In the present invention as best shown in FIGS. 5, 6a, 6b, and 6c, the first arm 32 will have a length which is the same as or greater than the length of the second arm 34. The length of the second arm 34 will preferably be between 0.5-1.5 times the desired slice thickness.

Preferably, each of the arms 32, 34 will be comprised of a length of at least 0.3 mm to allow for sharpening. In FIG. 6a, the length of the first arm 32 is 1.5 mm and the length of the second arm 34 is 1 mm. In FIG. 6b, the length of the first arm 32 is 1.702 mm and the length of the second arm 34 is 1.502 mm. In FIG. 6c, the length of the first arm 32 is 2.213 mm and the length of the second arm 34 is 0.823 mm.

### E. Operation of Preferred Embodiment.

The blade edge 30 configuration utilized with the present invention may vary depending on the product being cut as well as the type of blade 20 being used. By allowing the angle of the bisectional line 36 of the cutting wedge to the cutting plane to be independent from the cutting angle, necessary force for a clean, efficient cut is minimized. While the cutting wedge angle is independent of the temperature of the product being sliced, the angle of the cutting wedge to the cutting plane may be varied depending on the temperature of the product to reduce cutting forces for slicing by allowing a portion of the cutting wedge (i.e. the back bevel 33) to cross the cutting plane during slicing.

FIG. 6a illustrates a first orientation and blade configuration for cutting a first product of a certain compressibility into slices of a certain thickness. In this example, the angle of the cutting wedge between the first and second arms 32, 34 is 30 degrees. The angle between the bisectional line 36 of the cutting wedge and the cutting plane 16 is 18 degrees. The length of the first arm 32 is 1.5 mm and the length of the second arm 34 is 1 mm. The angle between the second arm 34 and the cutting plane 16 is 3 degrees.

FIG. 6b illustrates a second orientation and blade configuration for cutting a first product of a certain compressibility into slices of a certain thickness. In this example, the angle of the cutting wedge between the first and second arms 32, 34 is 30 degrees. The angle between the bisectional line 36 of the cutting wedge and the cutting plane 16 is 15 degrees. The length of the first arm 32 is 1.702 mm and the length of the second arm 34 is 1.502 mm. The angle between the second arm 34 and the cutting plane 16 is 0 degrees.

FIG. 6c illustrates a third orientation and blade configuration for cutting a first product of a certain compressibility into slices of a certain thickness. In this example, the angle of the cutting wedge between the first and second arms 32, 34 is 30 degrees. The angle between the bisectional line 36 of the cutting wedge and the cutting plane 16 is 10 degrees. The length of the first arm 32 is 2.213 mm and the length of the second arm 34 is 0.823 mm. The angle between the second arm 34 and the cutting plane 16 is negative 5 degrees.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A product slicing apparatus, comprising:
a blade, wherein said blade includes a blade edge;
a first bevel formed on a first side of said blade edge, wherein said first bevel includes a first arm, wherein said first arm extends at a first angle with respect to a bisectional line extending through a tip of said blade edge; and
a second bevel formed on a second side of said blade edge, wherein said second bevel includes a second arm, wherein said second arm extends at a second angle with respect to said centerline extending through said tip of said blade edge.

2. The product slicing apparatus of claim 1, wherein a cutting wedge angle defined as an angle between said first and said second arm is between 12 degrees and 45 degrees.

3. The product slicing apparatus of claim 2, wherein said cutting wedge angle is 30 degrees.

4. The product slicing apparatus of claim 2, further comprising a first spine extending from said first arm away from said tip of said blade edge and a second spine extending from said second arm away from said tip of said blade edge.

5. The product slicing apparatus of claim 4, wherein said first spine is parallel with said second spine.

6. The product slicing apparatus of claim 5, wherein said first spine is at least four times the length of said first arm.

7. The product slicing apparatus of claim 6, wherein said second spine is at least four times the length of said second arm.

8. The product slicing apparatus of claim 1, wherein said first arm is the same length as said second arm.

9. The product slicing apparatus of claim 1, wherein said first arm is a greater length than said second arm.

10. The product slicing apparatus of claim 1, wherein said blade is comprised of an involute blade.

11. The product slicing apparatus of claim 1, wherein said blade is comprised of a circular blade.

12. The product slicing apparatus of claim 1, wherein said first angle is positive with respect to said bisectional line and wherein said second angle is negative with respect to said bisectional line.

13. The product slicing apparatus of claim 2, wherein said first arm has a length of between 1.5 mm and 2.3 mm and wherein said second arm has a length of between 0.75 mm and 1.6 mm.

14. A method of slicing a product with a product slicing apparatus, comprising:
providing a blade, wherein said blade comprises:
a blade edge;
a first bevel formed on a first side of said blade edge, wherein said first bevel includes a first arm, wherein said first arm extends at a first angle with respect to a bisectional line extending through a tip of said blade edge; and
a second bevel formed on a second side of said blade edge, wherein said second bevel includes a second arm, wherein said second arm extends at a second angle with respect to said bisectional line extending through said tip of said blade edge;
providing a product to be sliced with said blade;
orienting said blade edge such that said second bevel is at a first angle with respect to a cutting plane of said blade; and
slicing said product with said blade edge.

15. The method of slicing a product with a product slicing apparatus of claim 14, wherein said second bevel crosses said cutting plane.

16. The method of slicing a product with a product slicing apparatus of claim 14, wherein said first angle is comprised of positive 3 degrees.

17. The method of slicing a product with a product slicing apparatus of claim 14, wherein said first angle is comprised of 0 degrees.

18. The method of slicing a product with a product slicing apparatus of claim 14, wherein said first angle is comprised of negative 5 degrees.

19. The method of slicing a product with a product slicing apparatus of claim 14, wherein said blade is comprised of an involute blade.

20. The method of slicing a product with a product slicing apparatus of claim 14, wherein said blade is comprised of a circular blade.
